(19) United States
(12) Patent Application Publication
(10) Pub. No.: US 2015/0353834 A1
(43) Pub. Date: Dec. 10, 2015

(54) Polymeric Fire Retardant

(71) Applicants: Paul W. SCHMALZL, (US); Robert WARREN, (US); POLYMERIUM, LLC, Cheyenne, WY (US)

(72) Inventors: Paul W. Schmalzl, Greenville, SC (US); Robert Warren, San Diego, CA (US)

(21) Appl. No.: 14/759,034

(22) PCT Filed: Jan. 6, 2014
(86) PCT No.: PCT/US14/10315

§ 371 Date: Jul. 2, 2015

Related U.S. Application Data
(60) Provisional application No. 61/749,973, filed on Jan. 8, 2013.

(51) Int. Cl. C09K 21/14

(52) U.S. Cl. CPC C09K 21/14

(57) ABSTRACT

A novel system for using a high water content polymer and its various implementations to provide a means of evaporative fire retardation for buildings and structures. This invention will provide benefits that will reduce potential damage from adjacent fires or fast-spreading wildfires and provide fire fighting efforts with new means to a priori protect property.

This application claims the benefit of U.S. Provisional Application No. 61/749,973, entitled “Polymeric Fire Retardant System,” filed Jan. 8, 2013, the contents of which are hereby incorporated by reference.

### BACKGROUND OF INVENTION

Few things strike fear in people like watching their property go up in flames. There are many causes for such incidents, but one of particular interest in this invention is that of stray embers arriving from other burning sources like structures, forests and fields. This phenomenon is quite common in wind-swept wildfires common in certain parts of the world. It is also a concern in densely packed areas of buildings and homes and often results in additional resource expenditures solely to reduce the potential of fire spreading from the origination to other structures.

There has been a great deal of attention paid to reducing occurrence of fires in structures, including refined building materials and techniques and incorporation of additional systems like sprinklers. However, for existing structures few breakthroughs have been developed to help minimize the impact of spreading embers. That is the subject of this invention—a means to effect a fire retardant capability that can be in place prior to a fire event and can also be applied to help combat ember spread during an event.

### SUMMARY OF THE INVENTION

The invention described in this disclosure provides a novel system for using a high water content polymer and its various implementations to provide a means of fire retardant capability. This invention will provide benefits not previously available and at much lower initial and ongoing costs than alternative solutions.

In the preferred embodiment high water content polyacrylic acid-based copolymers are used as fire retardant coatings on structures, places and areas containing flammable materials that are to be protected from fire.

### DETAILED DESCRIPTION OF THE INVENTION

Fire prevention is a topic many people learn from an early age. The admonition “don't play with matches” goes well beyond simply worrying about a child hurting himself Rather, unlike so many potentially self-harming actions, playing with matches can bring significant destruction of property and potentially the loss of many lives. Even without specific actions, including careless acts of children, fires do happen. The question then is how best to deal with fires once started.

While the answer to that question depends greatly on the specifics of the situation, there are some general cases that may be addressed. For the purposes of this invention, the primary type of fire to be addressed are those started from fire embers coming from other sources, including burning structures, forest fires and the like. To deal with these types of fires, we propose the use of polymers, including high water content polyacrylic acid-based copolymers as fire retardant coatings on structures, places and areas containing flammable materials that are desired not to be burned.

Polymer compounds have been synthesized for decades and have a wide range of applications. Each developed for specific characteristics necessary for a primary application; polymers are unique combinations of chemicals (monomers) in specific formulations and conditions to enable creation of the polymer. Often, however, the application of a particular polymer to something other than its primary application can yield very interesting results.

The Polymeric Evaporative Fire Retardant (PEFR) system is just such an application. Of particular interest for PEFR is the ability to retard fire from external sources for structures like buildings and houses by providing a protective layer of moisture (e.g., water) on exposed surfaces. Effective fire retardation can have direct and immediate effects in the preservation of property and life. Widespread applications of the invention disclosed herein can additionally help extend valuable resources by reducing or eliminating sites requiring attention during large conflagrations.

For the purposes of this description, a high water content polymer is considered. Such a polymer may be found in U.S. Pat. No. 6,201,089 (“Example Polymer”). This patent describes hydrophilic polymers with 95-99.9% water content. While developed for other applications, the characteristics of the polymers described are very suitable to the application of the PEFR. Additionally, as will be described later, the formulation of the polymer provides features that enhance the benefits beyond simple fire retardation.

The PEFR is best considered in terms of a layer of polymer on the roof of a building or house as shown in FIG. 1 or any exterior surface of a structure that may be exposed to embers and flames. This layer 102, which can be varied in thickness, will conform to the structure surface 101 in order to maximize the fire retardation from the structure. Properly hydrated, the PEFR will be predominately water that, as fire embers encounter the PEFR, they will naturally extinguish.

Moreover, as the temperature rises because of nearby fires, which can cause ignition in some materials, the water will change phase from a liquid to a gas. That is, it will evaporate, and will serve to reduce the surface temperature sufficiently to prevent ignition due to high temperatures. It will be obvious that, while water is suitable for PEFR and used throughout this document, other fluids or fluid mixes may be used as well. Additionally, many variables can be manipulated to gain maximum advantage for the location or specific use. Some of these variables may include thickness of the layer, format of the layer, and enhancements.

In the preferred embodiment, the PEFR polymer is applied to an existing structure, nominally a roof. Sprayed on to the roof surface, as one would consider a standard coating like paint or roofing sealant, the PEFR polymer can be applied either dry or pre-hydrated.

Alternatively, as in the case of application during immediate need like a local or approaching fire, the application may be seen as a replacement for simple dousing water or fire retardant foams that are applied with traditional firefighting equipment.

In the preferred embodiment, in a spray-on application, the hydrated polymer will be part of a liquid mix that includes an adhesive component. The adhesive component provides for a mean to keep the polymer layer attached to the structure surface in addition to any natural adhesion found in the polymer itself. The correct mixture of polymer to adhesive can be varied depending on the target surface type, expected thickness of the polymer layer, environment and other variables.

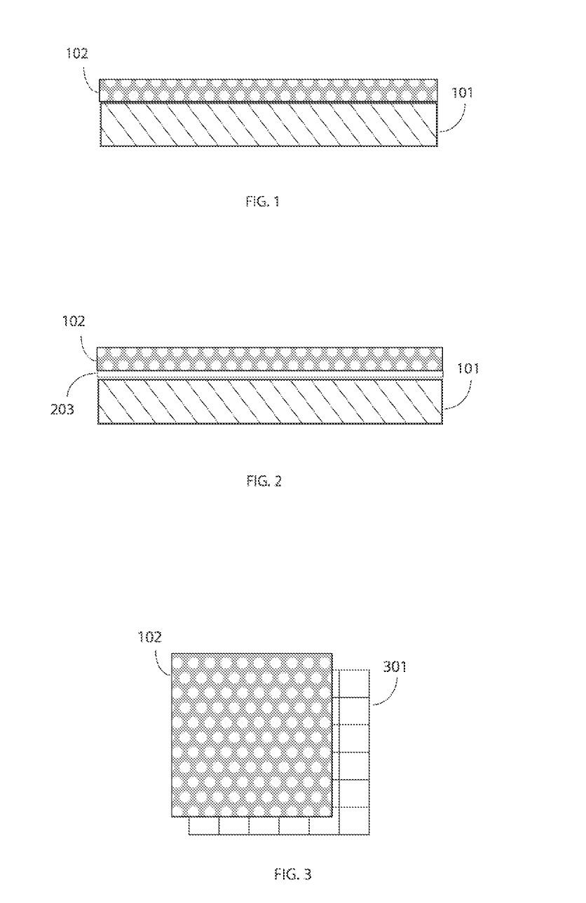

Alternatively, a layer of adhesive may be applied prior to the spray-on of the polymer as shown in FIG. 2. In this case, polymer layer 102 is affixed to structure 101 with adhesive layer 203.

Some applications may not be amenable to a spray-on treatment. In such cases, the ability to spread the polymer material with a brush, mop or other device becomes preferable. It may also be forced into existing flexible roof surfaces like tar or membranes. Further, it may be allowed to settle into porous surfaces, like stone or gravel coatings. This is particularly useful in some flat roof applications like those common in industrial businesses.

The advantage of the spray-on application is that specific structure design does not matter. For example, pitched-roof houses can be comprised of asphalt or wood shingles, tile and gravel, all of which are compatible with a spray-on coating. An advantage of this application is that it may improve the appearance of the surface and extend the viability or life of the surface. This may be the case, for instance in the case of wood shingles that have become aged and brittle over time but that are effectively sealed with the polymer mix so as to render the wood more fire resistant. The inclusion of a tint element into the polymer coating may further enhance the esthetics of the application.

Alternative means of application of the polymer are also considered in this invention, including installation in anticipation of potential fire occurrences one might expect in high fire risk areas. In one alternative, the polymer may be cast in a form very similar to tiles such that each are individually applied to the surface. Such may be more suitable in cases that require more precise polymer thickness or other special considerations. In the case of such a tiling arrangement, adhesive may be applied prior to application or may already be integrated into one or more surfaces of the polymer tile. Here again, the specific implementation may guide the choice.

Yet another alternative is to integrate the polymer into existing structural elements. For example, the polymer may be applied to the surface of or integrated into the composition of various roof treatments like tiles. The advantage of such an implementation is that it becomes a standard part of a workflow during construction or refurbishment. A further advantage of such an implementation is that it allows for a sporadic or patterned distribution to allow for access to portions of the structure without potential damage from stepping on the polymer itself.

For applications to surfaces like roofs that require repeated access, an enhancement to this invention is the incorporation of channels, gaps or superstructures interspersed in the polymer coating layer. These will allow for access ways without risking damage to the layer itself. It is important to note that direct exposure to the sun is not necessary for performance, which allows for application below existing structures like catwalks and access paths.

An alternative embodiment of this invention is the incorporation of the polymer into various firefighting equipment such that dousing fluids will have additional viscosity and other qualities to allow for the fluids to remain at the location doused. The inclusion of some additional adhesive quality further allow for operators to pre-emptively cover structures more in advance than currently means allow.

Still another implementation of the PEFR is the formation of the polymer into a rollable form that is similar to other roofing materials. As such, the polymer may be fully or partially hydrated or unhydrated at any time prior to installation and rolled onto the surface. As with other implementations, an adhesive may be integrated or may be added at the time of PEFR installation.

It is important to consider that a hydrated polymer may be quite fragile. Polymer fragility may be mitigated somewhat with increased thickness but may also incorporate additional means to provide structural stability. A simple example to be considered, as shown in FIG. 3, is a mesh 301 around which the polymer 102 is cast. Such casting may an active part of the polymerization process or it may be post-polymerization stages and include adhesive to provide connection to the mesh. The mesh may be flexible or rigid.

An alternative to the mesh idea is the application approach similar to that used when applying stucco to buildings. In this case, a mesh is installed and the material is applied to the mesh either by spraying, trowelling, some other method or a combination of these. The key to the application is to rely on the mesh as a structure with the polymer engulfing the mesh.

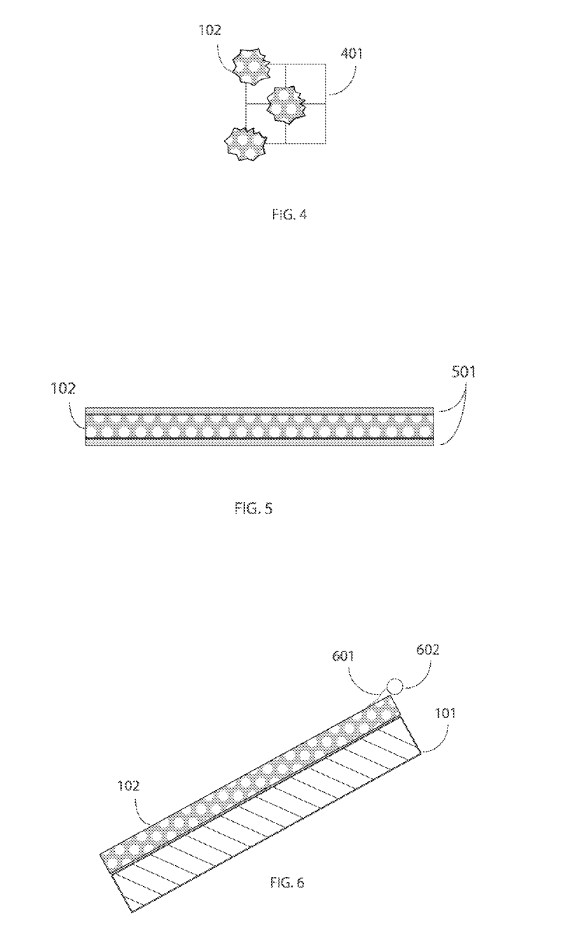

Whether formed directly around a mesh or applied on a mesh, the structure provides additional benefit during periods of dehydration. One would reasonable expect a drying polymer to separate during shrinkage. With a properly designed and sized mesh, the shrinkage will take place in the mesh gaps while allowing the polymer to remain attached to the mesh. An example of this is shown in FIG. 4, in which polymer 102 is affixed to mesh 401 such that any shrinkage occurs in the gaps of the mesh 401, thereby maintaining the integrity of the polymer layer upon rehydration.

Additionally, the polymer may be encapsulated in some porous layer as shown in

FIG. 5. The porous layer 501 will allow for water to enter and escape the polymer 102 but will also provide for some protection of the polymer itself. The porous layer 501 may be that of a fabric material or rigid and may be on a single side or both top and bottom. It may also provide additional fire retardation capability. An advantage of this implementation is the ability for the polymer layer to be installed temporarily or moved and adjusted to fit the specific and/or changing needs.

Another advantage of the PEFR being encapsulated in a porous layer 501 is that it can help contain the polymer if it becomes completely dehydrated. In a case of complete dehydration, a nominally 95% water content polymer can shrink, become brittle and fracture into small pieces.

It is with possible shrinkage in mind that the selection of a flexible adhesive may be beneficial. With sufficient elasticity in the adhesive component, during dehydration the PEFR remains in place and will upon rehydration return to its desired form. This capability can be enhanced by applying in a very specific manner such that the polymer is applied in the dry state and in a pattern that allows for rapid expansion upon rehydration.

An enhancement to this invention is the ability to process in the polymer in a means that allows for expansion upon hydration in only the vertical direction. Such an enhancement will mitigate concerns of expansion and contraction during wet and dry periods, respectively, and any resulting mechanical separation.

An additional enhancement is the incorporation of known fire retardant compounds into the polymer, either by mixing of the compound into the polymer (either dry or hydrated) or as a monomer of fire retardant properties into the polymer chain.

An alternative implementation of the invention is the ability to actually polymerize the polymer upon application to a UV-exposed source. For example, the incorporation of a UV initiator for polymerization may be sufficient to enable the UV delivered by the sun to actually cause polymerization after the polymer's monomer mix has be applied to a surface.

It will be well understood that this PEFR may also be applied to other than roof structures and that application format may vary. Such an alternative application may be for the sidewalls of buildings and structures or open areas that can take advantage of the fire retardation and temperature reduction capabilities of PEFR.

In the preferred embodiment, the polymer used will have sufficient hydrophilicity that rehydration will be easily accomplished. In some high humidity areas, such rehydration may occur naturally during low-heat periods like at night. An alternative that is particularly useful during a fire threat like a moving wildfire is to provide water to rehydrate the polymer. As shown in FIG. 6, providing water 601 may be accomplished in a manner similar to that provided to lawns and landscaping plants with sprinklers, misters or trickle water systems 602. Fortunately, such a system can be tied directly into a landscape system such that it operates during non-peak fire times. The use of non-potable water, used in many locations specifically for irrigation, is readily compatible with this embodiment of PEFR.

An advantage of using water as the working fluid for PEFR is that it also provides a high degree of reflectivity. This is beneficial in that it further helps reduce heat energy that may cause ignition. Such reflectivity may be enhanced with the addition to the polymer of specific elements or pigments or the selection of one or more adhesive components.

Another advantage of using a high water content polymer is that overspray or run-off during application can provide water retention capabilities to surrounding soils and plants. This may not only help reduce progress of fire, but can be incorporated into the soil for the benefit of plants, grass and trees by retaining water necessary for growth and survival.

While a suitable polymer, like those used in the examples herein, will have sufficiently small pore size to prevent plant and other intrusions into the polymer matrix, the water content may invite surface growth. An enhancement to this invention is the inclusion of elements or compounds into the mix to further enhance the inability for plant matter to grow.

Another enhancement is to address the possibility that exposure to the sun's UV rays may degrade the polymer over time. To mitigate this, at least partially if not completely, UV inhibitor means and compounds may be incorporated into the polymer or the polymer mix.

A further enhancement to this invention is the incorporation of known flame retardants into the polymer or admixed with the polymer. This is to further enhance the ability of the applied hydrated polymer to resist burning and ignition by embers and/or flames. Examples of these flame retardants include, but are not limited to, phosphorus compounds, brominated and/or bromine containing compounds, and antimony, phosphorus or bromine containing monomers that are incorporated into the polymer as part of the polymer structure. In all cases, the inclusion of these flame retardant materials known to the industry are incorporated here in as enhancements to this invention.

### EXAMPLE

Existing high water content polymers like that disclosed in U.S. Pat. No. 6,201,089 provide a straightforward basis for an example implementation of this invention.

A hydrated polymer, combined with a liquid adhesive component is mixed with a working fluid to provide the proper application viscosity. Viscosity requirements may be based on several factors, but at a minimum will have to allow compatibility with application means. For the sake of this example, the application means is a spray system commonly used in the construction trade for applying paints and other surface coatings.

For an example application with a pre-emptively installed polymer layer, after clearing an existing roof from debris and easily removed dirt and residue, an operator uses the spray system to apply a layer of the polymer mix. Environmental factors like temperature and humidity may impact the speed at which the operator can apply the material. As is often the case in applying paint, multiple applications may be necessary to provide the desired thickness. While the desired thickness is likely determined well before application, it is understood that it may be increased at a later time. After the desired area is coated to the desired thickness of the polymer mix, the operator simply lets it set and the adhesive cure in place.

For this example, we assume that during peak summer seasons the polymer will likely face periods of extended dryness. To maintain the polymers beneficial actions, during the relatively cooler nighttime a sprinkler system tied to the non-potable landscape water source sprays water on the polymer-covered roof. This will ensure optimal performance during a potential fire event. Such a sprinkler cycle will not be necessary if there is rain or sufficient moisture available in the atmosphere.

In an area of high humidity there is always a concern about the growth of mold, mildew, algae and other unwanted plant life. For our polymer mix, this is easy dealt with by periodic application of a simple sodium bicarbonate and water mixture. Not only does this provide moisture to the polymer but the nature of the mixture will kill any surface growth. Such an application may be ideally performed at least once per year. Should additional action be required against molds, mildews, algae or other unwanted growth—commercially available biocides, algaecides (etc.) can be applied as part of the water rejuvenation feed through the sprinkler system.

Should there be any work done on the roof system, ventilation system maintenance for example, any damage to the polymer layer is easily fixed with a simple spray of more polymer mix. There is not issue of compatibility with the existing polymer layer.

While specific polymer types and embodiments are cited in this description, it will be well understood by those schooled in the art that variations are possible. Nothing in this description is to be read as limiting with respect to such potential variations. Moreover, while synthetic polymers are used for example purposes, the invention disclosed herein may be applicable to the use of naturally derived or hybrid natural/synthetic formulations.

What is claimed is:

1. An evaporative fire retardant system comprised of a high water content polymer that holds water to a surface in order to enable fire prevention by the water being held by said polymer.

2. The evaporative fire retardant system in claim 1 in which an adhesive layer is applied to the surface prior to the application of the polymer layer.

3. The evaporative fire retardant system in claim 1 in which the polymer is applied in multiple layers to provide the appropriate thickness.

4. The evaporative fire retardant system in claim 1 that incorporates a hydration means.

5. The evaporative fire retardant system in claim 1 in which the high water content polymer is applied with firefighting equipment.

6. The application using firefighting equipment in claim 6 in which the high water content polymer is applied pre-emptively in anticipation of a fire condition.

7. The polymer of claim 1 that has sufficient hydrophilicity to allow rehydration from ambient humidity.

8. The polymer of claim 1 in which the polymer includes an adhesive monomer to enable said polymer to bond to the surface.

9. The polymer of claim 1 in which the polymer is mixed with a separate adhesive component to enable the polymer to bond to the surface.

10. The polymer of claim 1 in which the polymer includes a UV-resistance component.

11. The polymer of claim 1 in which the polymer includes an agent to minimize plant growth like mold.

12. The polymer of claim 1 in which the polymer is advantageous to water retention in soil used for plant growth.

13. The polymer of claim 1 in which the polymer incorporates flame retardant compounds.

14. The flame retardant compounds of claim 13 which include at least one of phosphorus compounds, brominated compounds, bromine containing compounds, antimony, phosphorus or bromine.

15. An evaporative fire retardant system comprised of a high water content polymer that holds water to a surface in order to enable fire prevention by the water being held in by said polymer and an element providing structural support to the polymer.

16. The evaporative fire retardant system of claim 7 in which the polymer is integrated with the structural support element prior to application.

17. The evaporative fire retardant system of claim 7 in which the polymer is integrated with the structural support element at the time of application.

18. The evaporative fire retardant system of claim 7 in which the structural support element is a mesh.

19. An evaporative fire retardant system comprised of a high water content polymer that holds water to a surface in order to enable fire prevention the water being held in by said polymer with said polymer being polymerized in place on the structure.

20. The polymerization of claim 11 in which the polymerization is effected by ultra-violet radiation.

21. The polymerization of claim 11 in which the polymerization is effected by heat.

22. An evaporative fire retardant system comprised of a high water content polymer that holds water to a surface in order to enable fire prevention the water being held in by said polymer that is created in forms similar to existing building elements in order to enable easy integration.

23. The forms of claim 15 that include tiles, shingles or siding.

24. The forms of claim 15 that include rolled surface coatings.

25. The forms of claim 15 that enable liquid application techniques.
